(19) United States
(12) Patent Application Publication
(10) Pub. No.: US 2006/0076427 A1
(43) Pub. Date: Apr. 13, 2006

(54) Lift truck with heating system

(76) Inventors: Joseph L. Schneider JR., St. Henry, OH (US); Patrick A. Tebbe, Anna, OH (US); Trevor A. Temple, Celina, OH (US)

Correspondence Address: STEVENS & SHOWALTER LLP, 7019 CORPORATE WAY, DAYTON, OH, 45459-4238, US

(21) Appl. No.: 11/247,406

(22) Filed: Oct. 11, 2005

Related U.S. Application Data
(60) Provisional application No. 60/617,728, filed on Oct. 12, 2004.

(51) Int. Cl. B60H 1/00; B60H 1/06

(52) U.S. Cl. 237/12.3 A; 237/28

(57) ABSTRACT

Systems, structures and methods are provided for heating an operator's compartment of a working vehicle. The heating system includes a first heat source arranged to direct heat towards at least one control on a control area. A second heat source is arranged so as to direct heat towards the operator's compartment, e.g., by radiating or otherwise moving heat within or about the operator's compartment into the operator's compartment. The second heat source may comprise a heat element mounted within or about the operator's compartment and/or heat drawn from a component of the vehicle, e.g., heat given off by motors, pumps, the battery, inverter, operator support, hydraulic fluid or other components within a power unit of the vehicle.

### CROSS REFERENCE TO RELATED APPLICATION

This application claims the benefit of U.S. Provisional Patent Application Ser. No. 60/617,728, filed Oct. 12, 2004, entitled “LIFT TRUCK WITH HEATING SYSTEM”, which is incorporated herein by reference.

### BACKGROUND OF THE INVENTION

The present invention relates in general to materials handling vehicles and more particularly, to systems, structures and methods for heating an operator's compartment of a materials handling vehicle.

Materials handling vehicles, such as fork lift trucks, may be provided with an open operator's compartment so that an operator may readily view the work environment, including the load being carried by the vehicle. However, with an open operator's compartment, the operator is exposed to the environment, including the ambient temperature in the area where the operator is working. For example, a forklift truck with an open operator's compartment may be used for moving items between locations in cold storage facilities such as a refrigerated warehouses or freezers. In such an application, an operator may be exposed cool and/or cold conditions for various periods of time.

Moreover, the ambient temperature may vary considerably when transitioning from one place to another. Thus, an operator of a forklift truck with an open operator's compartment may be required to adapt to changing temperatures while operating the vehicle. For example, a facility, such as a warehouse, may comprise cool or cold locations as well as relatively warmer locations. Under any of the above operating conditions, the time that a vehicle operator can work productively in the cool to cold environments may be reduced due to exposure to the operating conditions including the low temperature.

### SUMMARY OF THE INVENTION

Various aspects of the present invention provide systems, structures and methods that may be used individually or in combination to heat an operator's compartment of a materials handling vehicle for operation in cool and cold environments. Various aspects described herein are particularly suited for use with working vehicles such as materials handling vehicles in which an operator's compartment is at least partially open and not sealed from exposure to the outside environment. However, the various systems, structures and methods herein can be applied in any combination to any working vehicle where it is desired to provide heat to an operator's compartment.

According to one aspect of the present invention, a heating system is provided for supplying heat to a material handling vehicle having an open operator's compartment, a control area within the operator's compartment and an operator support for supporting an operator in a work operative position within the operator's compartment. The heating system comprises a first heat source arranged to direct heat about at least a portion of the control area in the operator's compartment. The first heat source may further direct heat towards at least one display, control on a control panel or other operator control within the operator's compartment. A shroud extends at least partially over the control area in cooperation with the first heat source so as to trap and circulate heated air that would otherwise escape from the open operator's compartment. The shroud may also block wind that would otherwise be directed at the operator.

A second heat source directs heat given off by at least one vehicle work operative component from a corresponding compartment of the vehicle into the operator's compartment. For example, the second heat source may comprise heat drawn from an alternating current (AC) inverter positioned behind an interior panel of the operator's compartment. A forced air device, such as a fan, may be arranged to direct heat from the AC inverter into the lower portion of the operator's compartment. Other exemplary work operative components may include a motor, a brake, a battery, a hydraulics system or vehicle electronics positioned within one or more compartments of the vehicle.

The second heat source may further include a heating device such as a resistive strip heater arranged to direct heat to the lower portion of the operator's compartment in cooperation with, or as an alternative to heat drawn from the AC inverter or other vehicle work operative component that is supplying heat to the operator's compartment. Further, an operator support, e.g., a back rest, armrest or seat within the operator's compartment, may have at least one operator support heating element for radiating heat through the operator support, e.g., by radiating heat to an operator in contact with the operator support while operating the vehicle. The heating element may comprise, for example, heated hydraulic fluid that is circulated through the operator support, one or more carbon fiber heating elements, or other suitable seat heating devices.

The heating system may further include a heat extractor arranged under a cowling in a control area or in another suitable location of the vehicle. The heat extractor includes at least one of a heating device such as a strip heater, a radiator that extracts heat from the vehicle hydraulic fluid or an air vented housing that draws heated air from one or more vehicle work operative components. The heat from the extractor may be distributed to the operator's compartment, e.g., via suitable ductwork or otherwise through open spaces of the vehicle.

Still further, control arrangements may be provided to selectively control one or more of the heat sources provided on the vehicle. For example, one or more of the heat sources may be tied to thermostats, switches or other automated or manual control devices. Further, heat sources may be tied to presence sensing devices so that the corresponding heat source is turned off when an operator is not present within the operator's compartment of the vehicle. Other features and characteristics of vehicle heating systems are set out in greater detail herein.

### BRIEF DESCRIPTION OF THE SEVERAL VIEWS OF THE DRAWINGS

The following description of the preferred embodiments of the present invention can be best understood when read in conjunction with the following drawings, where like structure is indicated with like reference numerals, and in which:

FIG. 1 is a perspective view of a rider reach truck incorporating a heated operator's compartment in accordance with various aspects of the present invention;

FIG. 2 is a perspective view of a power unit of the reach truck of FIG. 1, with select compartments exposed to illustrate a system and method for drawing heat from various exemplary components of the rider reach truck;

FIG. 3 is a perspective view of the power unit of the rider reach truck of FIG. 1 showing various components included in the operator's compartment;

FIG. 4 is another perspective view of the power unit of the rider reach truck of FIG. 1 showing various components included in the operator's compartment;

FIG. 5 is a view of a control area of the rider reach truck of FIG. 1, showing an aspect of the heating system for heating an area of the operator's compartment;

FIG. 6 is a view of the control area illustrating an alternative arrangement relative to FIG. 5, for heating an area of the operator's compartment;

FIG. 7A is a view of an operator support assembly in the operator's compartment having sections of a back rest and an arm rest cut away to illustrate an exemplary operator support heating device;

FIG. 7B is a view of an operator support assembly in the operator's compartment having sections of a back rest and an arm rest cut away to illustrate another exemplary operator support heating device;

FIG. 8 is a partial view of an inside panel of the power unit of the reach truck of FIG. 1, illustrating a heating element for providing heat to a lower portion of the operator's compartment;

FIG. 9 is a view of a portion of the power unit having the side panel below the operator support assembly opened to illustrate movement of air towards the heating element shown in FIG. 8;

FIG. 10 is a partial side view of opposite ends of the power unit of the reach truck of FIG. 1 illustrating an exemplary arrangement of heating elements in the side panels of the operator's compartment;

FIG. 11 is a perspective view of a heat extractor that may be used to provide heat to the operator's compartment of the reach truck of FIG. 1;

FIG. 12 is a top view of the reach truck of FIG. 1 illustrating an exemplary positioning of the heat extractor of FIG. 11;

FIG. 13 is a perspective view of a cowling to illustrate the addition of vents that output heat from the heat extractor of FIG. 11, and to further illustrate an alternative shape to the shroud over the cowling; and

FIG. 14 is a perspective view of the power unit of the reach truck of FIG. 1 illustrating an optional air curtain to reduce the loss of heat from the open access operator's compartment.

### DETAILED DESCRIPTION OF THE INVENTION

In the following description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

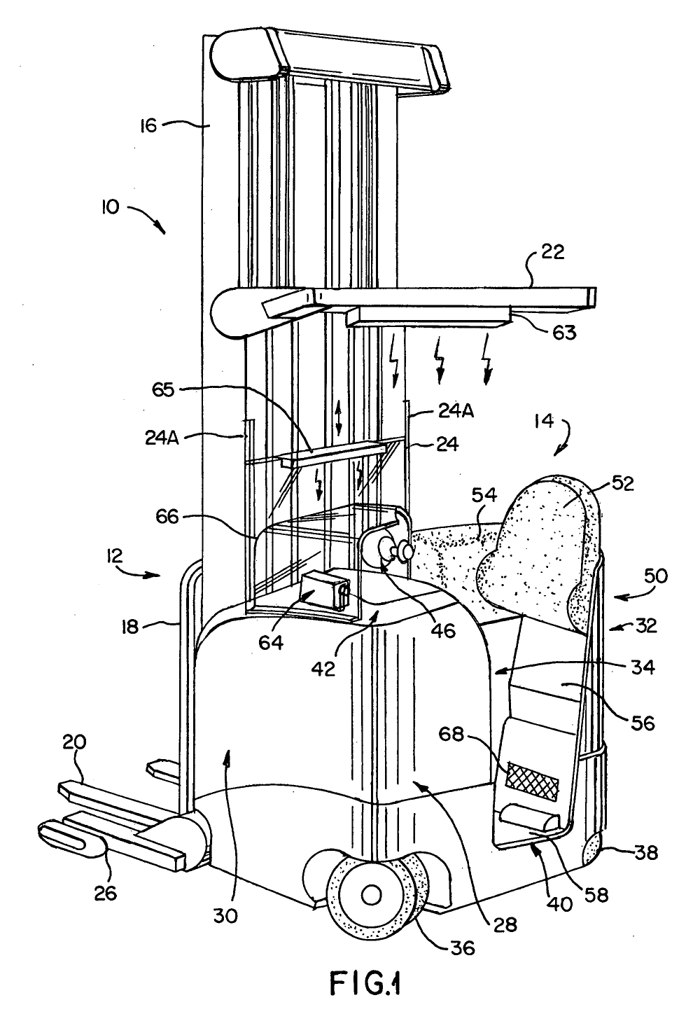

Referring now to the drawings, and particularly to FIG. 1, a materials handling vehicle 10, such as a rider reach truck, includes generally, a load handling assembly 12 positioned in the front of the vehicle 10 and a power unit 14 positioned to the back of the vehicle 10 behind the load handling assembly 12. The load handling assembly 12 includes a mast 16 that extends generally vertically from the power unit 14, a fork carriage mechanism 18 supported by the mast 16 and a pair of forks 20 that are carried by the fork carriage mechanism 18. The fork carriage mechanism 18 allows the forks 20 to be repositioned with respect to the vehicle 10, and may include a reach mechanism for extending the forks 20 forward of the vehicle 10 and retracting the forks 20 back towards the mast 16. A side shift mechanism may also be provided to permit side to side movement of the forks 20 relative to the mast 16, and a tilt mechanism may be provided to permit the forks 20 to be tilted relative to horizontal.

The mast 16 supports an overhead guard 22 that extends over at least a portion of the power unit 14. Moreover, an optional window member 24 extends across at least a portion the mast 16 as will be described in greater detail below. The mast 16 further supports a pair of outriggers 26, which are arranged such that a select one of the outriggers 26 flanks generally to the outside of a corresponding one of the forks 20.

The power unit 14 may include one or more compartments for supporting vehicle components. For example, as shown, the power unit 14 includes a motor compartment 28, a battery compartment 30 and a compartment 32. Depending upon the particular vehicle requirements, other compartment arrangements may be provided, e.g., to provide a separate compartment for hydraulics system components or other vehicle components. Further, the power unit 14 includes an operator's compartment 34 from which a worker can operate the vehicle and its load handling features. The operator's compartment 34 is adjacent to each of the motor compartment 28, battery compartment 30 and compartment 32 as illustrated.

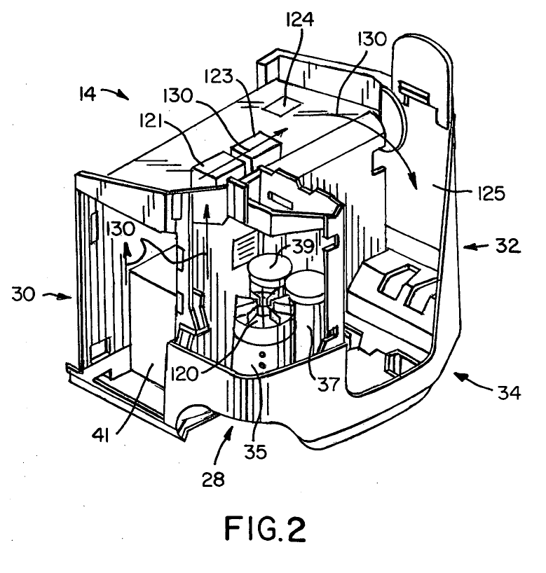

With reference to FIGS. 1 and 2 generally, the motor compartment 28 houses one or more motors for powering the vehicle 10 or the load handling features of the vehicle 10. For example, as best seen in FIG. 2, the motor compartment 28 may house a traction motor 35, hydraulics motor 37, a high speed reserve motor 39 and/or other vehicle components. The traction motor 35 is provided to drive a steered wheel 36, which is shown to the left and rear of the power unit 14 in FIG. 1. Also, a caster wheel 38 is mounted to the power unit 14, which is shown in the back right hand corner of the power unit 14 in FIG. 1. The hydraulics motor 37 powers hydraulics functions provided on the vehicle 10, e.g., to raise and lower the forks 20, and may provide steering assist. The vehicle hydraulics system may further comprise associated hydraulics lines, pumps and other components that are not illustrated in FIG. 2 for clarity of discussion. The high speed reserve motor 39 may be provided as a reserve power source, e.g., for the implementation of high speed raise functions with the forks 20. The traction motor 35, the hydraulics motor 37, the high speed reserve motor 39 and any other drive devices provided on the vehicle 10 do not need to be located in the same compartment and may thus be distributed about the power unit 14, depending upon the particular vehicle and vehicle design.

The battery compartment 30 houses one or more batteries 41 as seen in FIG. 2. The batteries 41 provide electrical power to the traction motor 35, hydraulics motor 37, high speed reserve motor 39 and to the electrical systems within the vehicle 10. The compartment 32 may be provided to house an alternating current inverter or other system electronics or power conditioning systems, an example of which is described in greater detail below with reference to FIGS. 8-10.

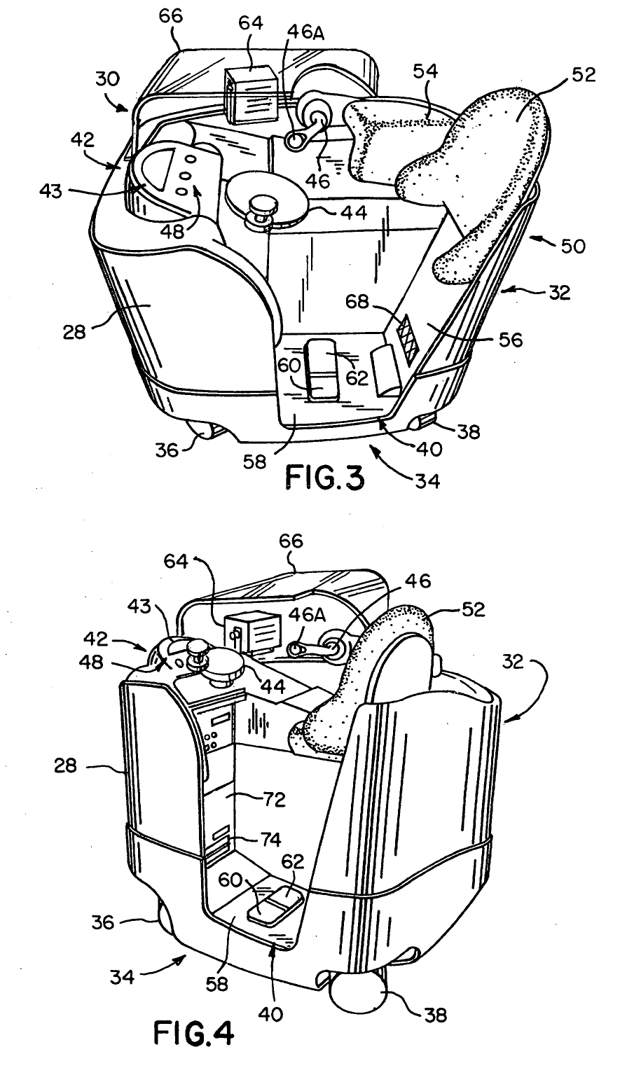

With reference to FIGS. 1 through 4 generally, the operator's compartment 34 defines an operator's station from which an operator may drive the vehicle 10 and control the load handling features of the vehicle 10. The operator's compartment 34 is open and is thus not fully enclosed. As such, an operator within the open operator's compartment is at least partially exposed to the environment outside of the vehicle 10. For example, as illustrated, there is no roof or other enclosing structure about the upper portion of the operator's compartment 34. The operator's compartment 34 further includes an access opening 40 from the back of the vehicle 10, which allows for unimpeded ingress and egress to the operator's compartment 34.

The operator's compartment 34 also includes a control area about which an operator can control the vehicle and its load handling capabilities. The control area includes the controls, display areas, and other features provided by the vehicle 10 as well as the adjacent supporting structures. For example, as shown, the control area of the vehicle 10 encompasses a cowling 42 (not shown in FIG. 2) that cooperates with an instrument and control region 43, a steering tiller 44 and a control handle 46.

The cowling 42 is a hood that extends over the compartments 28, 30 of the power unit 14 to provide a cover or panel through or upon which the various controls of the vehicle 10 may be mounted. The instrument and control region 43 is mounted over the cowling 42 and may include levers, switches, buttons or other devices for controlling features of the vehicle. The steering tiller 44 extends through the cowling 42 generally below the instrument and control region 43 as shown, and is provided for controlling the direction of travel of the vehicle 10. The control handle 46 also extends through the cowling 42 for controlling the speed of travel and the forward and reverse direction of the vehicle 10. Controls 46A may be provided on the control handle 46 for controlling other features of the vehicle 10, such as the height of the forks 20, the fork extension, fork tilt and/or side-shift. An optional display area 48 may further be provided, e.g., adjacent to the instrument and control region 43 to display truck status and other operational information, such as the battery voltage, the fork height, the weight of the load on the forks 20, and other information to assist the operator of the vehicle 10.

Also mounted within the operator's compartment 34 is an operator support assembly 50, which is attached to the right side of the power unit 14 as seen in FIGS. 1, 3, 4 (not shown in FIG. 2). The operator support assembly 50 is provided for supporting an operator in a work operative position within the operator's compartment 34 and includes a back rest 52 and an arm rest 54 as illustrated. The back rest 52 is supported against a first interior panel 56 of the operator's compartment 34. The arm rest 54 is positioned adjacent to the back rest 52 and is supported by the cowling 42 proximate to the control handle 46. The vehicle 10 is intended for standing operation as shown, and as such, no seat bottom is illustrated. However, the present invention may be utilized in any working vehicle where it is desirable to provide a heated operator's compartment. As such, the operator support assembly 50 may include any suitable structures, including seats, supports and rests depending upon the vehicle.

The operator's compartment 34 may also include one or more foot pedals positioned about a floor area 58 of the operator's compartment. There are two pedals 60, 62 as shown. The left-hand pedal 60 may operate an electric switch to control braking of the vehicle 10 and the right-hand pedal 62 may operate an electric switch, e.g. a presence sensing switch, which detects the presence of a vehicle operator. The presence sensing switch operated by the pedal 62 may be tied into appropriate vehicle electronics including networked computer systems so that actuation of the pedal 62 is necessary to operate the vehicle 10. The pedal 62 may further be tied into a heating control scheme to selectively activate one or more heating sources based upon whether an operator is present in the operator's compartment as will be explained in greater detail below.

### The Heating System

The vehicle 10 includes several heat sources that can be utilized to warm an operator in the operator's compartment 34. The heat sources may also be provided to warm areas of the vehicle 10, including electronics or mechanical structures, e.g., to prevent condensation, frosting etc. The vehicle 10 may further include one or more features that provide operator comfort while operating the vehicle in cool or cold environments. For example, structures may be provided to reduce wind chill or otherwise block exposure to cool or cold air while operating the vehicle 10 as will also be explained in greater detail below.

With reference to FIG. 1, the overhead guard 22 may be equipped with an overhead heat source 63, e.g., one or more strip heaters such as resistive heating elements, which may be used to direct heat downward towards the vehicle operator. Under this arrangement, the overhead heat source 63 may be coupled to control electronics on the instrument and control region 43, e.g., a switch for manually turning the overhead heat source 63 on and off, or the overhead heat source 63 may be coupled to controls in the controls 46A, or within the display area 48 shown in FIGS. 1 through 3, or elsewhere about the vehicle 10, so that a user may manually turn on and off the heat source.

Further, the overhead heat source 63 may be coupled to system electronics. For example, referring briefly to FIGS. 1 and 2 generally, the overheat heat source 23 may be coupled to control electronics 121, 123 and optionally, a corresponding sensing device 124, e.g., a thermostat, temperature regulator, sensor, temperature controller, or other device necessary to implement a desired temperature control scheme. The sensing device 124 is schematically illustrated as being positioned in the power unit 14 for clarity of discussion herein. However, in practice, the sensing device 124 may be positioned about the vehicle 10 anywhere practical as the specific application dictates. Thus, the sensing device 124 may monitor the temperature or other conditions associated with the vehicle 10, e.g., the temperature of the heating device itself, the ambient temperature or other temperature within or outside the operator's compartment 34, etc. Additionally, multiple sensing devices 124 may be provided where each device is associated with one or more heat sources that will be described more fully herein. Under this arrangement, each sensing device 124 may be uniquely positioned to correspond with an associated heat source. The control circuitry may further include switches, valves and other control devices necessary to implement the desired temperature control scheme.

With brief reference to FIGS. 1, 3 and 4 generally, as yet another example, control electronics may couple the pedal 62 or other presence sensor located about the operator's compartment 34 to the overhead heat source 63 so as to preserve battery life by turning off the overhead heat source 63 when the control electronics detects that no operator is in the vehicle 10. Still further, a combination of manual and automated control schemes described above may be provided to control the overhead heat source 63.

Referring back to FIG. 1, the window member 24 may be positioned so as to form a shield generally in the area in front of an operator of the vehicle 10, e.g., positioned between the operator's compartment 34 and the load handling assembly 12, to deflect cold breezes and reduce wind chill effects that may be experienced by the vehicle operator during operation of the vehicle 10, especially when driving in a forks forward direction. As shown in FIG. 1, the mast 16 supports the window member 24. The window member 24 may alternatively be connected to other locations on the vehicle 10, e.g., the power unit 14.

The window member 24 may frost up, e.g., when driving between cold storage environments and warm environments. As such, the window member 24 may be vertically adjustable, e.g., using a window mounting arrangement 24A, such that the vehicle operator or other personnel may either manually or automatically reposition the window member 24. For example, the window member 24 may cooperate with the window mounting arrangement 24A such that the window member 24 is telescopically extendible and retractable in a vertical direction. Alternatively, the window member 24 may be continuously repositionable, e.g., by sliding the window member 24 along channels or similar features of the window mounting arrangement 24A, or the window member 24 may be settable in two or more discrete positions.

The window member 24 may also include a window heat source 65 such as heater tape, thin strands of wire or other window defrosting and/or heating elements. The window heat source 65 may be coupled to control electronics on the instrument and control region 43, e.g., a switch for manually turning the window heat sources 65 on and off. Further, the window heat sources 65 may be coupled to the to control electronics 121, 123 and optionally, a corresponding sensing device 124 in a manner analogous to that described above with reference to the overhead heat source 63. Under this arrangement, a sensing device 124 may comprise a thermostat, temperature regulator or other automated electronic control device mounted in the vicinity of the window member 24 for selectively operating the window heat sources 65, e.g., based upon measured temperature or other predetermined conditions. Still further, a combination of manual and automated control may be provided to control the overhead heat source 65 as described more fully herein.

One or more heat sources may also be provided to generate heat from within the operator's compartment 34 when the vehicle 10 is being operated in cool or cold environments. A control area heat source 64, e.g., a fan heater, radiator, convection heater, strip heater, coil heater, ribbon heater, ceramic disc heater, etc., is arranged to direct heat about the control area of the vehicle 10. For example, as illustrated, the control area heat source 64 provides heat generally into the operator's compartment 34 from an area proximate to the cowling 42 or elsewhere about the control area of the vehicle 10, e.g., to provide heated air in an area of the operator's compartment 34 that is otherwise open to the environment. The control area heat source 64 may further direct heat in the general vicinity of one or more of the operator controls, such as the instrument and control region 43, the steering tiller 44, the control handle 46 and/or display area 48, which is likely to be where the operator's hands will be located while operating the vehicle 10.

A shroud 66 extends upward and over at least a portion of the cowling 42 and provides a structure that serves to trap and circulate heated air that would otherwise escape the open operator's compartment 34 in the general area of the control area heat source 64. For example, as illustrated, the shroud 66 extends at least partially over the cowling 42 in cooperation with the control area heat source 64 so as to trap and circulate air heated by the control area heat source 64, and may thus trap heat in one or more of the general areas of the controls, e.g., the instrument and control region 43, the steering tiller 44, the control handle 46 and/or display area 48. Thus, the shroud 66 may serve to warm the operator and/or one or more of the various vehicle controls. The structure of the shroud 66 may also serve to shelter the operator by deflecting cold breezes and by reducing wind chill effects that may be experienced by the vehicle operator during operation of the vehicle 10.

With reference to FIG. 5, the control area heat source 64 may comprise a heating unit 78A mounted to the cowling 42. The heating unit 78A may be coupled to the cowling 42 by a connecting arrangement 79 that allows a heating surface 80 of the heating unit 78A to be pivoted vertically, rotated horizontally and/or otherwise repositioned. Thus, the heating unit 78A may provide directed heat to predetermined locations within the operator's compartment 34 of the vehicle 10. For example, the heating unit 78A may be used to warm the hands and body of the truck operator and/or provide heat to the instrumentation, controls and other vehicle components about the control area.

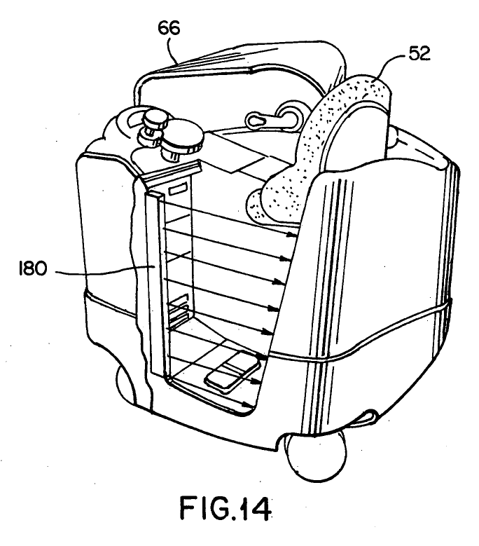

The shroud 66 may trap and direct heat, including heat generated by the heating unit 78A, e.g., in an area where an operator's hands are likely to be placed during vehicle operation. With brief reference to FIG. 13, an alternate configuration of the shroud 66 illustrates a profile that is contoured and chamfered around at least a portion of its edge 66A. Thus, the particular configuration of the shroud 66 may depend for example, upon the desired heating characteristics of the vehicle 10, the amount of wind blocking that the shroud 66 is to perform, and the visibility requirements of the operator of the vehicle.

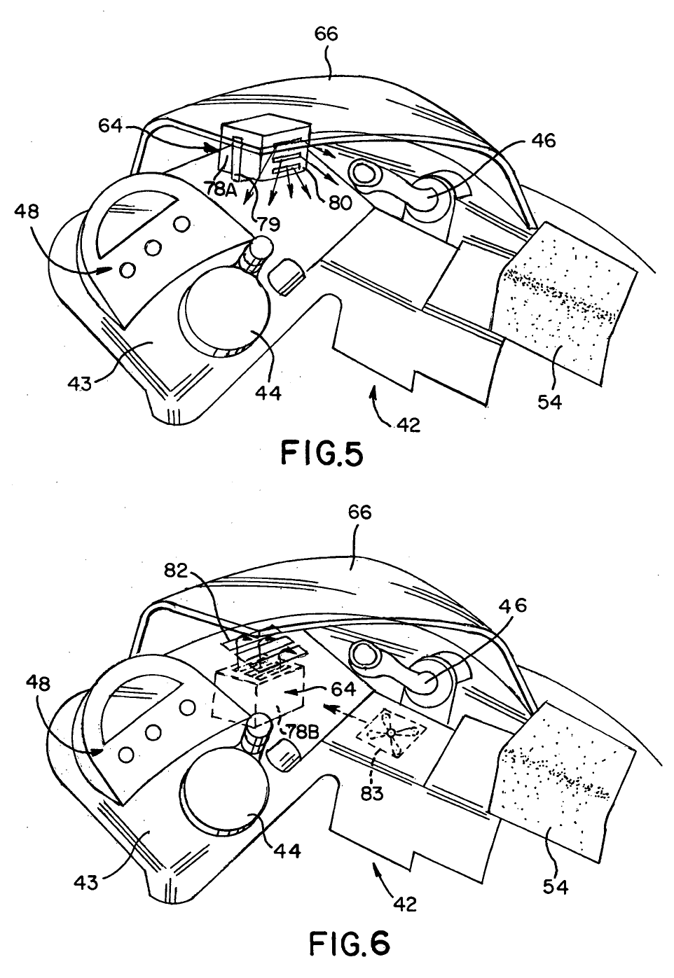

Referring to FIG. 6, according to another aspect of the present invention, the control area heat source 64 is relocated from a position above the cowling 42, e.g., as discussed above with reference to FIG. 5, to a position underneath the cowling 42. As shown, the control area heat source 64 may comprise a heating unit 78B, which directs heated air up from underneath the cowling 42. The heated air passes through vents 82 in the cowling 42 to enter the operator's compartment 34. The vents 82 may include adjustable fins or other adjustable features so that the operator can determine the direction of the heated air.

One or more fans 83 may also be positioned so as to direct heat to travel underneath the cowling 42 and through the vents 82 into the control area, e.g., by directing heat from the heat source 78B, and/or by drawing heat derived by one or more alternative sources, e.g., at least one vehicle work operative component such as vehicle electronics, motor, brake, hydraulics, the battery, etc. Thus, the control area heat source 64 may not require a dedicated heating device such as the heating unit 78B where a fan or fans 83 are able to draw sufficient heat under the cowling 42 from vehicle work operative components.

The control area heat source 64 can also be positioned anywhere between or beyond the positions shown in FIGS. 5 and 6. That is, the control area heat source 64 may be located at other positions about the cowling 42, or the control area heat source 64 may be physically spaced from the cowling 42, e.g., using a suitable mounting bracket or support hardware. The layout of the operative controls about the cowling 42, e.g., the location of the instrument and control region 43, the steering tiller 44, the control handle 46 and/or the display area 48, as well as the heating requirements of the vehicle 10 may thus influence the location of the control area heat source 64 and optionally, the location of the vents 82. For example, FIGS. 1, 3 and 4 illustrate the control area heat source 64 positioned generally towards the left hand side, right hand side, and in the middle of the cowling 42 respectively to illustrate exemplary flexibility in directing heat using the control area heat source 64. Moreover, the control area heat source 64 may be manually controlled, e.g., manually turned on or off, automatically turned on or off, or the control area heat source 64 may be coupled to the vehicle electronics 121, 123 and a corresponding sensor 124 (seen in FIG. 2) for automatic control of the control area heat source 64 in a manner analogous to that described more fully above.

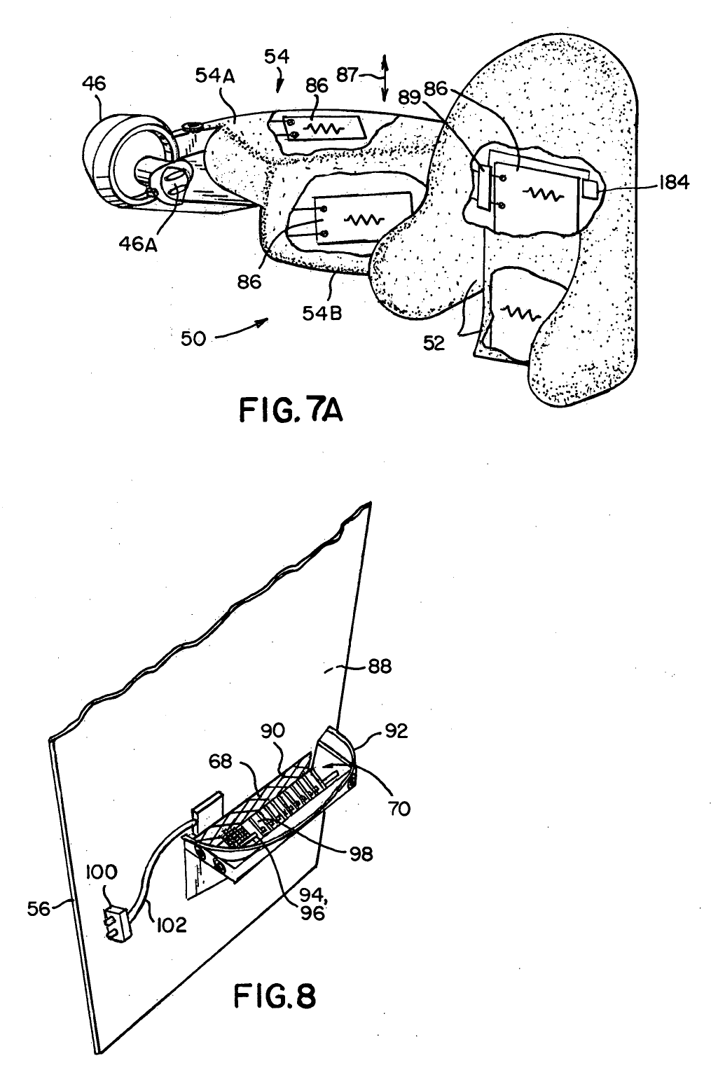

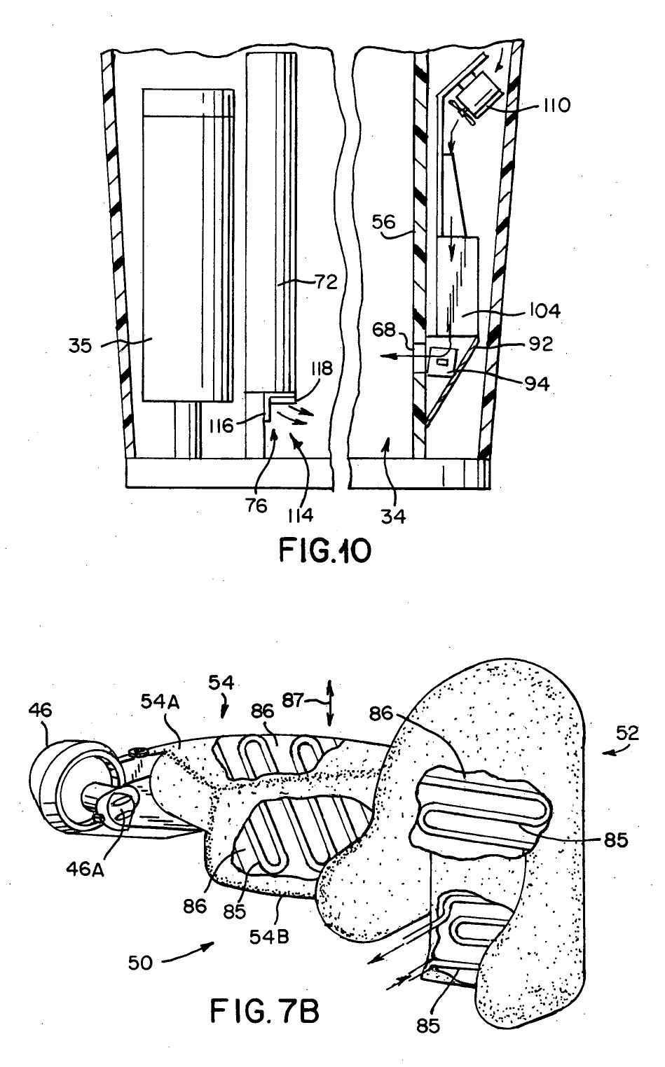

Referring to FIGS. 7A-7B, the operator support assembly 50 includes one or more operator support heating elements 86. The operator support heating elements 86 may comprise any structure that provides heat, e.g., to an operator in contact with the operator support assembly 50. For example, one or more operator support heating elements 86 may be stitched under upholstered areas of the operator support assembly 50. Alternatively, the heating elements 86 may be applied on a top surface of a standard configuration operator support assembly 50, and the heating element(s) 86 may be wrapped in suitable upholstery, e.g., a vinyl wrap.

The operator support heating element 86 in the back rest 52 is shown in the center of the back rest 52 within a generally flattened spot. Under this arrangement, the operator support heating element 86 avoids the radius of curvature of the back rest 52. However the operator support heating element(s) 86 may be made conformal to the back rest 52 if desired. For stand up vehicles, the operator support heating elements 86 may be extended to provide heat to the hip/lower back area as well. The specific backrest configuration will dictate where the operator support heating elements 86 may be applied. Moreover, where the vehicle 10 includes a seat bottom for sit down operation, the operator support heating elements 86 may be further provided in the seat portion as well as in the backrest portion of the seat.

As shown, the arm rest 54 includes a top portion 54A and a side portion 54B. A heating element 86 is positioned in each of the top portion 54A and the side portion 54B. An operator support heating element 86 may also be placed in the back rest 52. As such, heat from the operator support heating elements 86 radiates through the back rest 52 and arm rest 54 so that the back, side and right arm (as shown) of the operator may be warmed. Further, the backrest 52 and/or armrest 54 may be made adjustable either independently or together as a unit, e.g., by adjustment in a vertical direction according to arrows 87 to accommodate vehicle operators of varying height.

Moreover, the operator support heating elements 86 may be manually controlled, e.g., manually turned on or off, automatically turned on or off, or the operator support heating elements 86 may be coupled to the vehicle electronics 121, 123 and/or a corresponding sensor, e.g., sensor 124 (seen in FIG. 2) for automatic control of the operator support heating elements 86 in a manner analogous to that described more fully above.

As another illustrative example, a pressure sensitive switch or other pressure sensing device 184 (not shown in FIG. 7B) may also be provided to selectively turn on or off the operator support heating elements 86 in the operator support assembly 50. Thus, if an operator is not in a work operative position with respect to the operator support assembly 50, the operator support heating elements 86 may be turned off. The above concept can be extended to sit down types of vehicles, e.g., by placing the pressure sensing device 184 so as to detect an operator in a seated position.

With specific reference to FIG. 7A, the operator support heating elements 86 may be implemented using carbon fiber heating members, which are schematically represented by a grid and resistor element. The carbon fiber heating member may heat to a constant temperature, or may be adjustable between two or more heat settings. For example, the operator support heating elements 86 may be coupled to a controller 89 such that the carbon fiber heating members may adjusted between a low heat setting, e.g., around 100 degrees Fahrenheit (approximately 38 degrees Celsius) and a high heat setting, e.g., around 108 degrees Fahrenheit (approximately 42 degrees Celsius).

With brief reference to FIG. 7B, the operator support heating elements 86 may also be implemented using hydraulic fluid from the vehicle hydraulics system. As schematically represented, hydraulic fluid may be circulated through lines 85 to provide heat to the operator support assembly 50. Under this arrangement, the lines 85 can be routed through the back rest 52, through the arm rest 54 or any portions thereof. Further, while hydraulic fluid and carbon fiber heater alternatives are illustrated, other heat elements may alternatively be used to implement each operator support heating element 86.

Referring to FIG. 8, the first interior panel 56 is illustrated, removed from the remainder of the vehicle 10 for clarity. The view in FIG. 8 shows a back surface 88 of the first interior panel 56, which opens into the compartment 32, and reveals one exemplary implementation of another heat source that is suitable for heating the lower portion of the operator's compartment 34 e.g., to warm the operator's legs and feet. As shown, the first interior panel 56 includes a vent opening 90 over which first panel vents 68 are positioned. Attached to the first interior panel 56 projecting around a portion of the periphery of the vent opening 90 is a first panel duct 92. The first panel duct 92 is generally trough shaped and extends up and away from the first interior panel 56.

Within the first panel duct 92 is a strip heater 94, which is shown as a resistive bar 96, having a plurality of fins 98 for drawing heat from the resistive bar 96. The heat radiated by the resistive bar 96 exits the first interior panel 56 through the first panel vents 68 to supply heat to the lower portion of the operator's compartment 34. A control box 100 provides control and strain relief to a cable 102 connecting to the resistive bar 96 when the first interior panel 56 is removed from its installed position. As with the other heat sources described more fully herein, the resistive bar 96 may include a temperature adjustable feature (either automatically or manually) for controlling the temperature thereof, and/or the resistive bar 96 may be automatically or manually controlled to turn on or off in a manner analogous to other heat sources described more fully herein.

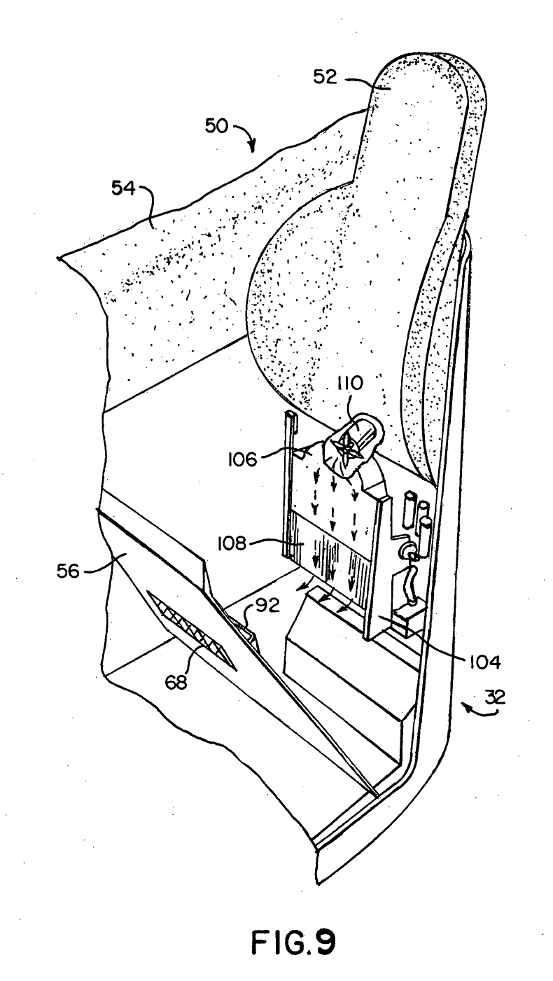

In certain implementations, e.g., in forklift trucks that use alternating current (AC) motor(s), large AC inverters are used to convert the direct current (DC) power supplied by the battery 41, into the AC current needed to drive the motors. The AC inverter typically generates a substantial amount of heat, which is normally forced out openings in the side of the vehicle 10 and away from the operator's compartment 34. However, the heat generated by the AC inverter can be directed to heat the operator's compartment 34 instead of being exhausted from the vehicle 10. Referring to FIG. 9, an AC inverter 104 is positioned below the back rest 52, behind the first interior panel 56 of compartment 32. A heat retaining and air flow directing cover 106 is provided over the AC inverter 104 above heat sink fins 108 to direct air over the AC inverter 104 in a downward direction. Heat generated by the AC inverter 104 (and by other heat generating components of the vehicle 10, e.g., motors, pumps etc.) may be drawn and directed down towards the first panel vents 68 using a fan 110 or other suitable device capable of drawing hot air through the vehicle 10.

As schematically depicted in FIG. 9, a heat source is arranged so as to direct heat into the operator's compartment 34 by drawing heat emitted by at least one vehicle work operative component, i.e., a component of the vehicle 10 that is provided for a function other that solely providing heating, e.g., to support a work or power operative function such as the AC inverter, motors, batteries, control electronics, brakes, hydraulics, etc. For example, as illustrated, the fan 110 draws air through the vehicle 10 and directs the air across the heat sink fins 108 and AC inverter 104, out through the first panel vents 68, and into the operator's compartment 34. Under this arrangement, the heat output through the vents 68 may comprise a combination of heat generated by the resistive bar 96 and from the heat drawn from the AC inverter 104 (and optionally other heat generating vehicle work operative components of the vehicle 10).

If an existing vehicle is being retrofitted with one or more heat sources as set out herein, then any vent holes on the outside of the power unit 14 designed to pull heat away from the operator's compartment may be plugged, sealed or otherwise closed off, at least during times in which the operator desires to heat the operator's compartment 34. Also, any existing fans or other air moving devices may need to be reversed to draw the heat into the operator's compartment instead of directing the heat to the outside of the vehicle 10.

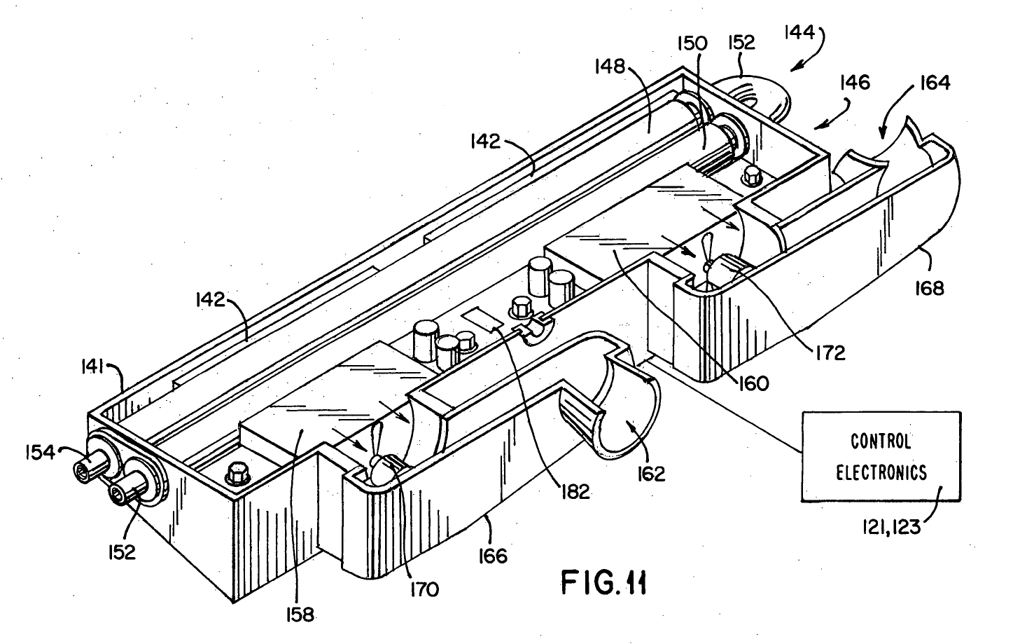

Referring to FIG. 10, heat from the AC inverter 104 is channeled through the first panel duct 92, which fits underneath the AC inverter 104. The heated air is then directed from the first panel duct 92 through the first panel vents 68 into the lower portion of the operator's compartment 34. Also, as illustrated in FIG. 10, the second interior panel 72 may include a recess 114 that extends the lower portion of the operator's compartment 34, for example, to accommodate the ends of an operator's feet. Under such an arrangement, a bracket 116 may be mounted to the horizontal, upper surface of the recess 114 to support an optional strip heater 118. The strip heater 118 is generally similar in construction to the resistive bar 96, and is used to radiate heat into the operator's compartment 34 generally in front of the operator when the operator is in a working position with respect to the operator support assembly 50. For purposes of illustrating the flexibility of various aspects of the present invention, the resistive bar 96 (see FIG. 8) is illustrated with fins or heat sinks 98 and the strip heater 118 is illustrated without such heat sinks or fins to demonstrate that any number of variations of heating devices may be used within the scope of various aspects of the present invention.

Alternative heat sources may be provided, e.g., to heat the lower portion of the operator's compartment 34. Moreover, the configurations of the heat sources can vary. For example, heat from the strip heater 118 may flow from the recess 114 out into the lower portion of the operator's compartment 34. Further, the strip heater 118 may be positioned in other reasonable locations depending for example, upon the configuration of the specific vehicle. As with the other heat sources described more fully herein, the strip heater 118 may include a temperature adjustable feature (either automatically or manually) for controlling the temperature thereof, and/or the strip heater 118 may be automatically or manually controlled to turn on or off in a manner analogous to that described more fully herein.

Numerous other vehicle work operative components of the power unit 14 are capable of producing heat, which can be channeled into the operator's compartment 34. As noted with reference to FIGS. 9 and 10, a fan 110 can be used to draw heat generated by the AC inverter 104 across the resistive bar 96 and/or the AC inverter 104 and into the lower portion of the operator's compartment 34 via the vent(s) 68 on the first interior panel 56. The same fan 110 can be used to draw heat from other heat generating components of the power unit 14 and direct that additional heat into the operator's compartment 34. Referring back to FIG. 2, heat from the motor compartment 28 and battery compartment 30 may be channeled through the power unit 14 to the lower portion of the operator's compartment 34 as schematically indicated by the directional arrow 130.

For example, as noted above, the motor compartment 28 includes the traction motor 35, hydraulics motor 37 and a high speed reserve motor 39. Also as shown, a brake 120 is mounted on the traction motor 35. The motor compartment 28 may also house additional components such as a steering motor, a traction motor gearbox, and any other necessary motor support structures that also generate heat during operation. Further, in cooperation with the hydraulics motor 37, a hydraulic reservoir, a manifold and necessary hydraulic lines, pumps, valves, etc., may also generate heat. The heat from the various components in the motor compartment 28 may be channeled through the power unit 14 to the lower portion of the operator's compartment 34 as schematically indicated by the directional arrow 130. The requirements of a specific vehicle 10 will determine the specifications for that vehicle's motor and hydraulic systems, and such systems need not be the same as that illustrated.

The battery compartment 30 houses one or more batteries 41 for supplying power to the vehicle 10, which also generate heat that can be drawn into the operator's compartment 34, e.g., as schematically indicated by the directional arrow 130. Depending upon the specific application, certain operations may utilize quick charges or opportunity charges to provide periodic charges to the truck battery. Essentially, operators use breaks, lunch shifts and other times that a vehicle is non-operational to provide brief periods of charge to the battery. This charging technique is more often used as an alternative to changing the batteries on multi-shift operations. During such opportunity charging operations, the battery may generate additional heat, which may further be captured and utilized as a source for the heating truck.

The movement of heat from components of the vehicle 10 may be carried out using suitable duct work or manifolds. Where no duct work or manifolds are provided, the heat may move through the open accesses provided in the design of the power unit 14, e.g., in the motor compartment 28, battery compartment 30 and/or any intervening compartments between corresponding vents and the heat sources. For example, as schematically shown, the heat from the motor compartment 28 moves through and/or over the battery compartment 30, in the direction of the arrow 130, picking up heat from additional components of the vehicle that generate heat, such as the battery 41 and optionally from vehicle electronics modules 121, 123 or other electronic components provided in the vehicle 10.

The heat moves down into the right hand side of the vehicle 10 through compartment 32, where the fan (seen in FIG. 9) moves the heat into the lower portion of the operator's compartment 34. Thus, the heat is pulled from under the cowling 42 through the power unit 14. Additionally, fans and other sources may be used to direct the heat from the motor compartment 28 out through the left hand side of the operator's compartment 34, e.g., through vents 74 in the second interior panel 72 as shown in FIG. 4.

Referring to FIG. 11, another exemplary heat source may be derived by a heat extractor 140. The extractor 140 comprises three heat sources as shown, including drawn/forced air, which may be drawn into the extractor housing 141 via extractor vent 142, heat extracted from a circulating fluid via radiator 144, e.g., from the hydraulic system, and heat derived from one or more heating devices 146. A forced air device such as one or more fans is operatively configured to direct the flow of heated air within the heat extractor to the operator's compartment 34 as will be described in greater detail below. In practice, the extractor 140 may comprise all three of the above-described heat sources, or any combination thereof, depending upon the specific application.

The radiator 144 includes a first radiator tube 148 and a second radiator tube 150. As shown, the first and second radiator tubes 148, 150 are serially connected together by a suitable coupler 152. Hydraulic fluid may be tapped at a suitable position within the vehicle to flow into the first radiator tube 148 through a suitable input nozzle 154. The hydraulic fluid then flows through the coupler 152, through the second radiator tube 150 and out a suitable output nozzle 156. For example, the hydraulic fluid may be tapped at a hot spot and routed through suitable hoses (not shown in FIG. 11) to the input and output nozzles 154, 156. Thus, the illustrated hydraulic system is free flowing and no oil restriction is generated. The coupler 152 need not be used to route the flow of hydraulic fluid from the first radiator tube 148 directly into the second radiator tube 150. Rather, the hydraulic fluid may be routed in any reasonable manner through one or both of the first and second radiator tubes 148, 150.

The first and second radiator tubes 148, 150 may include a plurality of fins or other structures to improve the collection of heat from the hydraulic fluid. The radiator tubes 148, 150 further serve to cool the hydraulic fluid, which allows more efficient operation of hydraulics devices. In cold applications, typical oil viscosity gets heavy. As such, specialized freezer oil is typically used in cold application trucks. However, as freezer oil heats up, efficiency is lost. Thus, by pulling the heat out of the oil, the oil temperature is lowered, which improves operating efficiency. Further, the extracted heat can be used as a heat source for the vehicle 10.

The heating devices 146 may comprise strip heaters such as the resistive bar heaters 96, 118 discussed with reference to FIGS. 7-9, or other suitable heating structures. As shown, there are two strip heaters 158, 160 that are positioned within the heat extractor 140 adjacent to the second radiator tube 150.

The extractor 140 further includes one or more output ports. There are two output ports 162, 164 as shown. The output ports 162, 164 are positioned to one side of the extractor 140, and are provided to direct the flow of heated air from the first and second radiator tubes 148, 150 and/or to direct the flow of heated air provided by the strip heaters 158, 160 along corresponding attached ductwork 166, 168. A fan 170, 172 or other suitable drawing device may be provided for drawing air through the extractor 140. The fans 170, 172 may be located in or adjacent to each port 162, 164. The fans 170, 172 may alternatively be placed elsewhere, e.g., in provided ducts, proximate to vents, or in other locations to direct heat to desired locations within the operator's compartment 34.

The fans 170, 172 may also pull air through the extractor vents 142 in the extractor housing. For example, electronics such as vehicle electronics modules 121, 123 or other electronics about the instrument and control region 43, on the cowling 42 (or elsewhere in the vehicle 10), may generate heat during operation. The heat provided by such electronics or other heat sources may be drawn through the extractor vents 142 and be distributed to the operator's compartment via the ducts 166, 168.

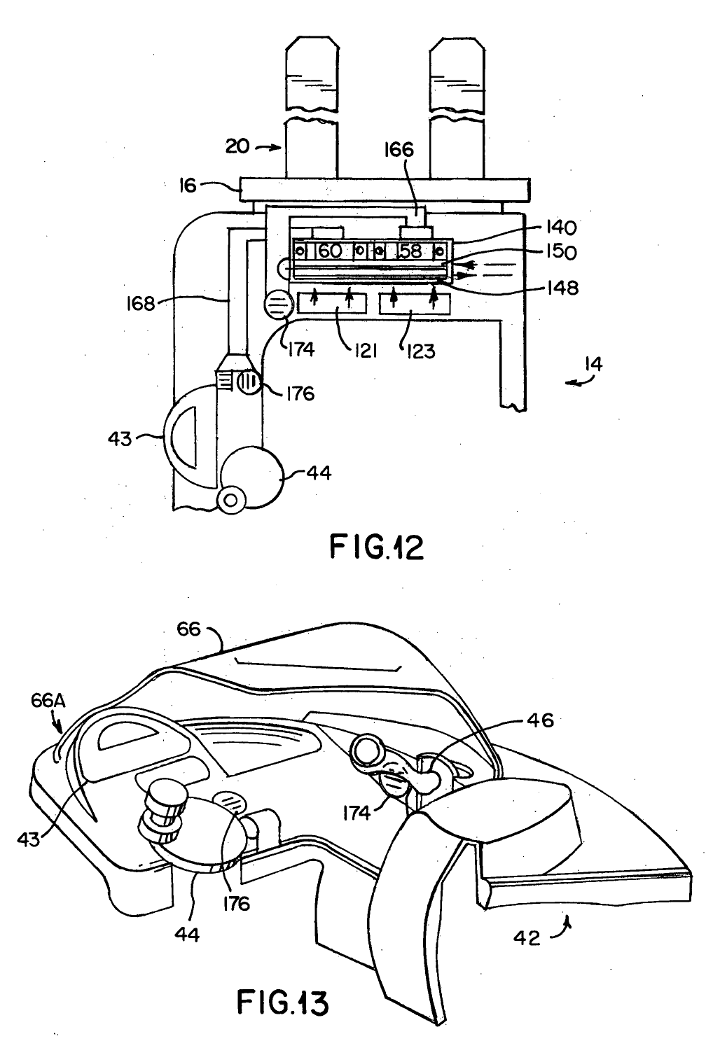

Referring to FIG. 12, the heat extractor 140 is arranged under the cowling 42. Moreover, each ductwork 166, 168 is terminated with a corresponding vent 174, 176 that mounts to the cowling 42 in an area where it is desired to provide heat. Referring to FIG. 13, the vents 174, 176 can be positioned in different sections of the vehicle 10. For example, as illustrated, the vent 174 is positioned along a first wall of the operator's compartment and the vent 176 is positioned along a second wall of the operator's compartment 34. Still further, the vents 174, 176 may be oriented in different planes to direct heated air to the most appropriate locations. For example, as shown the vent 174 is oriented substantially vertically whereas the vent 176 is oriented substantially horizontally.

The vents 174, 176 may be adjusted by opening or closing the vents. Moreover, the vents 174, 176 may be further adjusted, e.g., by rotating, swiveling or otherwise repositioning the fins of the vents 174, 176 to direct the heated air in a desired direction. The ductwork 166, 168 may further direct heat to other locations within the operator's compartment 34 or elsewhere about the vehicle 10, e.g., by supplying alternative or additional duct work and corresponding vents.

One aspect of the illustrated vehicle 10 is an open access operator's compartment 34. The open access facilitates quick ingress and regress from the vehicle. However, such open access may allow heat to escape from the operator's compartment 34. Further, when driving cab forward, cold air can enter the operator's compartment 34 via the access opening. As such, heat trapping, deflecting and/or retaining features may further be provided. For example, referring to FIG. 14, an air curtain may be created using a suitable air source 180 to eject a stream of air across the access opening 40. The air curtain is essentially forced air that traps the heated air within the operator's compartment 34. As an alternative, a barrier may be provided across at least a portion of the access opening 40 to trap heat into the lower portion of the operator's compartment. Still further, various heat sources described more fully herein may be utilized to provide heat to a fully enclosed operator's compartment.

Select and various heat sources may cooperate to provide heat concomitantly, or the provided heat sources may operate at different times, e.g., to achieve different heating requirements of the vehicle 10. For example, with reference back to FIG. 11, the various heat sources provided in the extractor 140 may be integrated in to a thermostatic or thermal management system that can be operated based upon desired heating requirements. For example, the hydraulic fluid will not provide instantaneous or near instantaneous heat. Rather, the hydraulic fluid will take a period of time to warm up. Similarly, the electronics or other heat sources that can be drawn through the extractor vents 142 may not provide heat immediately upon operation of the vehicle 10. However, the strip heaters 158, 160 can be operated to generate heat relatively quickly.

However, power is required to provide heat using the strip heaters 158, 160. Thus, in battery powered vehicles 10, the strip heaters 158, 160 will add to the draw of the battery 41. Comparatively, the heat from the hydraulics and vehicle electronics does not directly add to the power draw of the battery 41. As such, the heat from the hydraulics fluid via the radiator 144 and the heat from the control electronics via the extractor vents 142 do not come at a cost of battery power, other than the nominal energy required to operate the fans 170, 172.

As such, the vehicle electronics modules 121, 123 or other suitable control logic can utilize a sensing device to effect operation of the heat extractor 140 in an energy efficient manner to provide heat to the vehicle 10. As an example, a thermostat or other control device 182 is illustrated for sensing the temperature of the air in the extractor 140. Other sensing devices can also be utilized, e.g., the sensing device 124 illustrated in FIG. 2 and described in greater detail herein.

As an illustrative example, the control electronics 121, 123 may turn on the strip heaters 158, 160 until the radiator 144 can extract sufficient heat from the hydraulics fluid and/or sufficient heat is pulled through the extractor vents 142. After such time, the strip heaters 158, 160 can be turned off to conserve battery power. Similarly, the fans 170, 172 need not operate if the temperature derived by the extractor 140 is insufficient to provide a desired amount of heat. As such, the fans 170, 172 may be initially disabled, e.g., until a predetermined minimum temperature is detected.

Further, each of the heat sources throughout the vehicle 10 may be independently controlled, or the heat sources may be controlled together, e.g., based upon one or more predetermined conditions. For example, select ones of the heat sources may be turned on/off or regulated depending upon detected, sensed or inferred conditions, examples of which are described below. Also each heat source may be independently switched on or off (manually or automatically) depending upon the needs of the operator, such as by using select ones of controls provided on the instrument and control region 43 of the vehicle 10 in a manner analogous to that described in greater detail herein.

Various ones of the heat sources provided on the specific vehicle may further serve to increase the useful operation time of certain battery powered devices and peripherals associated with the vehicle 10. For example, the control electronics of the vehicle 10 may turn off heat sources that draw power from the battery, e.g., control area heat source 78A, 78B, strip heaters 70, 76, 158, 160 by detecting or otherwise sensing that sufficient temperature is being provided by sources of heat that do not require a direct draw of power from the battery to generate heat, such as the heat from the AC inverter 104, from the radiator 144 of the heat extractor 140, or heat given off by the motors and battery 35, 37, 39, 41, etc. For example, the system may turn on the strip heater 94 behind the first panel 56 as described with reference to FIGS. 8-10 at least until the AC inverter 104 generates a sufficient amount of heat to warm the operator's compartment 34.

Moreover, by heating the vehicle 10, battery powered tools used by the vehicle operator, e.g., a wireless radio frequency transceiver or other communications device that operates off of their own battery power may operate for longer periods of time because the batteries in such devices will stay relatively warmer. This effect may be more apparent when operating in cold environments where the cold temperature serves to reduce the normal operating life of a typically charged battery compared to similar operation in warmer environments due the physics of conventional batteries.

One or more of the heating devices, e.g., control area heat source 64, strip heaters 96, 118, 158, 160 can be tied to the pedal 62, e.g. a presence sensing switch, which detects the presence of a vehicle operator. Under this arrangement, deactivation of the pedal 62 causes the control electronics to infer that there is no vehicle operator in the operator's compartment 34. As such, the heat sources that would otherwise tend to drain the battery 41 may be turned off or down in temperature. Alternatively, presence sensing capability of the right hand pedal 62 may be replaced by one or more sensors, e.g., located under a floorboard within the floor area 58, or sensors may be placed elsewhere within or about the operator's compartment 34. Timers and other delay functions, e.g., as implemented in the control electronics 121, 123, may also be utilized alone or in combination with the above-described switches. Still further, the various heat sources may be independently switchable on or off, or the heat sources may be grouped for operative control.

Other control arrangements may also be implemented based upon inferred conditions. Heat sources that draw battery power, e.g., e.g., control area heat source 64, strip heaters 96, 118, 158, 160 may be tied to the power ON or other vehicle power switch, key or control so that when the vehicle 10 is powered down, the heating devices do not drain battery power. For example, certain vehicles include a power on pedal for the torque motor etc. that can be used to shut down operation when not engaged.

Further, weather stripping may be placed around the perimeter of the operator's compartment 34, around the instrument and control region 43 and about included duct work, e.g., 166, 168. The various heating systems herein provide heat for vehicles including those with open operator's compartments. Moreover, the heat is generated without reducing the available space for the operator in the operator's compartment 34 or interfering with the placement of operative controls.

Having described the invention in detail and by reference to preferred embodiments thereof, it will be apparent that modifications and variations are possible without departing from the scope of the invention defined in the appended claims.

What is claimed is:

1. A heating system for supplying heat to a material handling vehicle having an open operator's compartment, a control area within said operator's compartment and an operator support for supporting an operator in a work operative position within said operator's compartment, said heating system comprising:
a first heat source arranged to direct heat about at least a portion of said control area in said operator's compartment;
a shroud that extends at least partially over said control area in cooperation with said first heat source so as to circulate heated air that would otherwise escape said open operator's compartment;
a second heat source that directs heat given off by at least one vehicle work operative component from a corresponding compartment of said vehicle into said operator's compartment; and
at least one operator support heating element for radiating heat through said operator support.

2. The heating system according to claim 1, wherein said first heat source is mounted to a cowling so as to adjustably direct heat about said control area.

3. The heating system according to claim 1, wherein said first heat source is mounted underneath a cowling within said control area, so as to direct heat through corresponding vents in said cowling.

4. The heating system according to claim 1, wherein said first heat source comprises a fan positioned so as to direct heat from at least one vehicle work operative component to travel underneath a cowling and through at least one vent in said cowling within said control area.

5. The heating system according to claim 1, wherein said at least one vehicle work operative component comprises at least one of an alternating current inverter, a motor, a brake, a battery, a hydraulics system or vehicle electronics.

6. The heating system according to claim 1, wherein said at least one vehicle work operative component comprises an alternating current inverter positioned behind an interior panel of said operator's compartment, further comprising a forced air device arranged to direct heat from said alternating current inverter into a lower portion of said operator's compartment.

7. The heating system according to claim 1, wherein said second heat source further comprises at least one strip heater arranged to direct heat to said lower portion of said operator's compartment in cooperation with heat from said at least one vehicle work operative component.

8. The heating system according to claim 1, wherein said at least one operator support heating element comprises at least one carbon fiber heating element embedded in said operator support.

9. The heating system according to claim 1, wherein said at least one operator support heating element comprises a line embedded within said operator support through which hydraulic fluid is circulated.

10. The heating system according to claim 1, wherein said first heat source comprises an extractor arranged to direct heated air to travel under a cowling and into a control area through at least one vent, said heat extractor comprising at least one of:
at least one strip heater;
a radiator for extracting heat from a circulating supply of hydraulic fluid; and
a forced air device operatively configured to direct a flow of heated air.

11. The heating system according to claim 1, further comprising a window member positioned between said operator's compartment and a load handling assembly of said vehicle, said window member adjustable between at least two different positions.

12. The heating system according to claim 1, further comprising a window member positioned between said operator's compartment and a load handling assembly of said vehicle, said window member having a heating device thereon.

13. The heating system according to claim 1, further comprising an overhead heat source arranged to direct heat from an overhead guard positioned over said operator's compartment down towards said operator's compartment.

14. The heating system according to claim 1, wherein said operator's compartment further comprises an open access for ingress and egress, said system further comprising an air curtain configured to emit a curtain of air across said open access to reduce heated air escaping from said operator's compartment through said access opening.

15. A method of heating an operator's compartment of a material handling vehicle having an open operator's compartment, a control area within said operator's compartment and an operator support for supporting an operator in a work operative position within said operator's compartment, comprising:
directing heat from a first heat source about at least a portion of said control area in said operator's compartment;
providing a shroud that extends at least partially over said control area in cooperation with said first heat source so as to circulate heated air that would otherwise escape said open operator's compartment;
directing heat from a second heat source into said operator's compartment where said second heat source is derived by drawing heat emitted by at least one vehicle work operative component from a corresponding compartment of said vehicle into said operator's compartment;
heating said operator support using a third heat source for radiating heat to an operator in contact with said operator support while operating said vehicle
controlling at least one of said first, second and third heat sources according to at least one predetermined control condition.

16. The method according to claim 15, wherein said first heat source comprises a heat extractor having at least one strip heater and a radiator that extracts heat from hydraulic fluid of said vehicle, further comprising:
controlling said heat extractor such that said at least one strip heater is turned on at least until said radiator reaches a predetermined temperature.

17. The method according to claim 15, further comprising controlling at least one of said first, second and third heat sources upon detecting the presence of an operator within said operator's compartment.

18. The method according to claim 15, wherein:
said at least one vehicle work operative component comprises at least one of an alternating current inverter, a motor, a brake, a battery, a hydraulics system or vehicle electronics;
said second heat source further comprises at least one heating device; and
said at least one predetermined control condition comprises a detected temperature; further comprising:
controlling said second heat source such that said heating device is turned on only until said vehicle work operative component generates a sufficient amount of heat to warm the operator's compartment 34.

19. A heating system for a material handling vehicle comprising:
a heat extractor including:
a housing having at least one output port;
at least one strip heater positioned within said housing, each said heating device coupled to a power supply for controllably causing said heating element to generate heat;
a radiator comprising at least one tube positioned within said housing for extracting heat from a circulating supply of hydraulic fluid;
a forced air device arranged to direct heated air in said heat extractor into said operator's compartment of said vehicle; and
duct work that directs heated air from each output port of said heat extractor to an associated vent within said operator's compartment.

20. The material heating system according to claim 19, further comprising a controller configured to controllably turn on or off said at least one strip heater based upon a detected temperature.
